(19) United States
(12) Patent Application Publication
(10) Pub. No.: US 2026/0322769 A1
(43) Pub. Date: Oct. 15, 2026

(54) SWITCH WITH PLUGGABLE RESOURCE EXPANSION MODULE

(71) Applicant: Ruckus IP Holdings LLC, Horsham, PA (US)

(72) Inventors: Renjith Kumar Ponnappan, Fremont, CA (US); Kevin K. Ko, Fremont, CA (US); William J Ryan, San Jose, CA (US)

(21) Appl. No.: 19/639,998

(22) Filed: Apr. 6, 2026

Related U.S. Application Data
(60) Provisional application No. 63/786,355, filed on Apr. 10, 2025.

(51) Int. Cl. H04L 49/45

(52) U.S. Cl. CPC H04L 49/455

(57) ABSTRACT

A switch with flexible resources and capabilities is described. This switch includes an interface that remateably electrically and communicatively couples to a resource expansion module, where the resource expansion module includes a processor and memory, and the processor has more capabilities than a second processor that is non-remateably included in the switch. During operation, the switch may execute a software application on the processor in the resource expansion module, where the software application includes: Internet Protocol Security (IPSec), Bidirectional Flow Detection (BFD), Software-Defined Networking (SDN), software packet forwarding, or control plane offloading.

### CROSS-REFERENCE TO RELATED APPLICATION

This application claims priority to U.S. Provisional Patent Application No. 63/786,355, filed on Apr. 10, 2025, the contents of which are incorporated herein by reference in its entirety.

### FIELD

The described embodiments relate to techniques for executing a software application on a switch using a resource expansion module that is remateably electrically and communicatively coupled to the switch.

### BACKGROUND

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Washington), and/or another type of wireless network. For example, many electronic devices communicate with each other via wireless local area networks (WLANs) using an IEEE 802.11-compatible communication protocol (which is sometimes collectively referred to as ‘Wi-Fi’). In a typical deployment, a Wi-Fi-based WLAN includes one or more access points (or basic service sets or BSSs) that communicate wirelessly with each other and with other electronic devices using Wi-Fi, and that provide access to another network (such as the Internet) via IEEE 802.3 (which is sometimes referred to as ‘Ethernet’).

Certain electronic devices (which are sometimes referred to as ‘computer-network devices’) in networks support stacking. For example, 8-12 switches can be stacked and connected together, so that the switches function as a single node. In principle, software can execute on a processor in such a stack to allow the stack of switches to provide different services or applications.

However, in practice, economic constraints often limit the resources and capabilities (such as processor capabilities) in stacks of switches. Stated differently, it is typically too expensive to upgrade the resources and capabilities of all switches from a manufacturer. Consequently, the resources and capabilities of many switches typically make it difficult to execute software associated with some services or applications (such as computationally intensive services or application) in switch stacks.

### SUMMARY

A switch with flexible resources and capabilities is described. This switch includes an interface (such as a connector) that is configured to remateably electrically and communicatively couple to a resource expansion module, where the resource expansion module includes a processor and memory, and the processor has more capabilities than a second processor that is non-remateably included in the switch. During operation, the switch executes a software application on the processor in the resource expansion module, where the software application includes: Internet Protocol Security (IPSec), Bidirectional Flow Detection (BFD), Software-Defined Networking (SDN), software packet forwarding, or control plane offloading.

Note that the switch may be included in a stack of switches. In some embodiments, the switch may be at an arbitrary location in the stack of switches.

Moreover, the memory may include random access memory (RAM) that stores software instructions for the software application.

Furthermore, the switch may include first ports and second ports, where the first ports are associated with communication in a local area network (LAN), the second ports are associated with communication in a wide area network (WAN), and the resource expansion module is configured to manage communication via the second ports.

Additionally, in BFD, the resource expansion module may determine whether a point-to-point connection in a network is active.

In some embodiments, in IPSec, the resource expansion module may establish a connection via a secure tunnel, and encrypt or decrypt traffic communicated via the secure tunnel.

Moreover, the resource expansion module may be configured to provide a processing engine that processes packets in different levels in the processing engine.

Furthermore, the resource expansion module may include a Universal Serial Bus (USB) type C port.

Additionally, the resource expansion module may include or may provide the functionality of multiple network interface cards (NICs).

Another embodiment provides the stack of switches.

Another embodiment provides a computer-readable storage medium with program instructions for use with one of the resource expansion module, the switch or the stack of switches. When executed by the resource expansion module, the switch or the stack of switches, the program instructions cause the resource expansion module, the switch or the stack of switches to perform at least some of the aforementioned operations in one or more of the preceding embodiments.

Another embodiment provides a method, which may be performed by the resource expansion module, the switch or the stack of switches. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a flow diagram illustrating an example of a method for executing a software application using a switch in FIG. 1 in accordance with an embodiment of the present disclosure.

FIG. 3 is a block diagram illustrating an example of communication among switches in a stack of switches in accordance with an embodiment of the present disclosure.

FIG. 4 is a drawing illustrating an example of switches with resource expansion modules in accordance with an embodiment of the present disclosure.

FIG. 5 is a drawing illustrating an example of switch operation in accordance with an embodiment of the present disclosure.

FIG. 6 is a drawing illustrating an example of communication in a network in accordance with an embodiment of the present disclosure.

FIG. 7 is a drawing illustrating an example of load balancing in accordance with an embodiment of the present disclosure.

FIG. 8 is a drawing illustrating an example of port extension in accordance with an embodiment of the present disclosure.

FIG. 9 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A switch with flexible resources and capabilities is described. This switch includes an interface that remateably electrically and communicatively couples to a resource expansion module, where the resource expansion module includes a processor and memory, and the processor has more capabilities than a second processor that is non-remateably included in the switch. During operation, the switch may execute a software application on the processor in the resource expansion module, where the software application includes: IPSec, BFD, SDN, software packet forwarding, or control plane offloading.

By flexibly expanding the resources and the capabilities of the switch, these communication techniques may allow the switch to flexibly provide services or applications. Notably, the resource expansion module may allow the resources and capabilities to be selectively enhanced, thereby avoiding the cost constraints of enhancing the capabilities of every or even some switches from a manufacturer. Moreover, the resources and the capabilities of the resource expansion module may allow the switch to provide a resource-intensive service or application that cannot be performed by the second processor in the switch. Consequently, the communication techniques may enable the switch to be used in a variety of network architectures, including those in which functionality is moved or pushed from the core to the edge of the network (which is sometimes referred to as ‘smart edge’). Indeed, this flexibility may allow the switch to enable services or applications that currently cannot be performed using the existing capabilities and resources of switches. Therefore, the communication techniques may improve the user experience when using the switch and the associated networks.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi and Ethernet are used as illustrative examples.

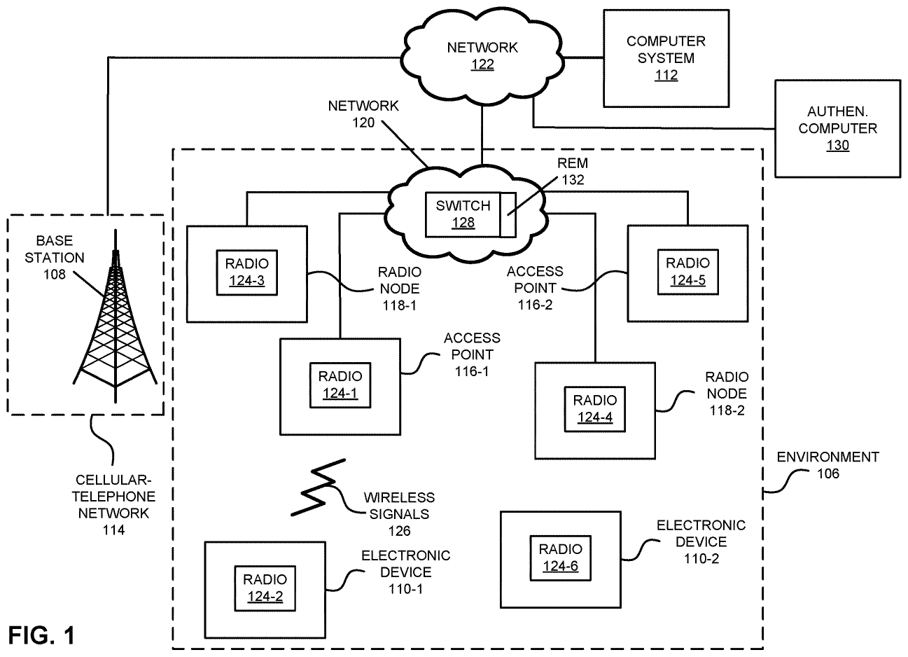

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device’ or a ‘computer-network device’). Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, computer system 112 (which may be a cloud-based controller that manages and/or configures access points 116, radio nodes 118 and/or switch 128, or that provides cloud-based storage and/or analytical services) and/or authentication computer 130 (such as a RADIUS server and/or an AAA server) using a wired communication protocol (such as Ethernet) via network 120 and/or 122. Note that networks 120 and 122 may be the same or different networks. For example, networks 120 and/or 122 may be: an LAN, an intra-net or the Internet. In some embodiments, network 120 may include one or more routers and/or switches (such as switch 128). In FIG. 1, note that a controller may provide various management, control and cluster functionalities, which may include: network management of access points; performing some of control plane functions (such as roaming); maintaining statistics related to traffic, health of access points, top applications used, number of clients and their capabilities; and/or other functions or functionality.

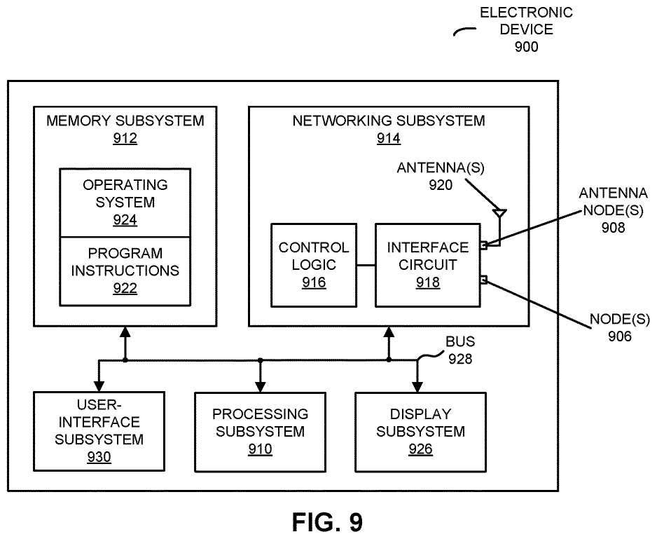

As described further below with reference to FIG. 9, electronic devices 110, computer system 112, access points 116, radio nodes 118, switch 128 and authentication computer 130 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, economic constraints often limit the resources and capabilities of switches. However, this can constrain the types of services and applications that are supported by switches. In order to address this problem, one or more switches (such as switch 128 or a switch in a stack of switches, not shown) may implement the disclosed communication techniques. Notably, switch 128 may remateably include a resource expansion module (REM) 132. For example, switch 128 may include an interface (such as a connector) that is remateably electrically and communicatively coupled to REM 128. REM 128 may include a processor and memory, and the processor may have more capabilities or performance (such as more core, a faster processing speed, etc.) than a second processor that is non-remateably included in switch 128. During operation, switch 128 may execute a software application on the processor in REM 132, where the software application includes: IPSec, BFD, SDN, software packet forwarding, or control plane offloading.

In some embodiments, switch 128 may include first ports and second ports, where the first ports are associated with communication in a LAN, the second ports are associated with communication in a WAN, and REM 132 may manage communication via the second ports.

Moreover, in BFD, REM 132 may determine whether a point-to-point connection in a network is active. This may take 10-100 ms and may be computationally intensive, and thus may benefit from the improved processor in REM 132. Furthermore, in IPSec, REM 132 may establish a connection (such as a point-to-point connection) via a secure tunnel, and encrypts or decrypt traffic (such as packets) communicated via the secure tunnel. When the encryption or decryption is implemented in software, it may be computationally intensive, and thus may benefit from the improved processor in REM 132. Additionally, REM 132 may be configured to provide a processing engine that processes packets in different levels in the processing engine.

In some embodiments, REM 132 may include a USB type C port.

Moreover, REM 132 may include or may provide the functionality of multiple NICs.

Note that, in embodiments where switch 128 is included in a stack of switches (not shown), switch 128 may be at an arbitrary location in the stack of switches. For example, switch 128 may be at an arbitrary position in the stack of switches. Stated differently, switch 128 may be any of the switches in the stack of switches (instead of a first switch or a switch at the top or bottom of the stack of switches).

In these ways, the communication techniques may allow the resources and capabilities of switch 128 to be flexibly expanded to allow switch 128 to provide additional services or capabilities. Moreover, this flexibility may allow switch 128 to overcome the economic or cost constraints associated with expanding the resources or capabilities of all switches or even a subset of the switches from a manufacturer. Consequently, the communication techniques may allow switch 128 to provide a resource-intensive service or application that cannot be performed by the second processor in switch 128. Therefore, the communication techniques may enable switch 128 to be used in a variety of network architectures, including those in which functionality is moved or pushed from the core to the edge of a network. Thus, the communication techniques may improve the user experience when using switch 128 and the associated network.

While the preceding discussion illustrated switch 128 performing the operations in the communication techniques, in other embodiments at least some of the operations may be performed by or in conjunction with another component in FIG. 1.

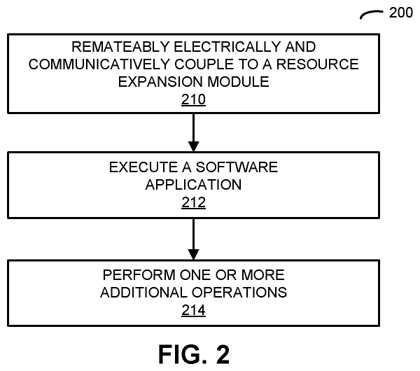

We now describe embodiments of the method. FIG. 2 presents a flow diagram illustrating an example of a method 200 for executing a software application, which may be performed by a switch, such as switch 128 in FIG. 1. The switch may include an interface (such as a connector) that is remateably electrically and communicatively coupled to a resource expansion module (operation 210), where the resource expansion module includes a processor and memory, and the processor has more capabilities than a second processor that is non-remateably included in the switch. For example, ‘non-remateably’ may include soldering the second processor to a circuit board in the resource expansion module. During operation, the switch may execute a software application (operation 212) on the processor in the resource expansion module, where the software application includes: IPSec, BFD, SDN, software packet forwarding, or control plane offloading.

Note that the switch may be included in a stack of switches. In some embodiments, the switch may be at an arbitrary location in the stack of switches.

Moreover, the memory may include RAM that stores software instructions for the software application.

Furthermore, in BFD, the resource expansion module may determine whether a point-to-point connection in a network is active.

Additionally, in IPSec, the resource expansion module may establish a connection via a secure tunnel, and encrypt or decrypt traffic communicated via the secure tunnel.

Note that the resource expansion module may include a USB type C port.

In some embodiments, the switch may optionally perform one or more optional additional operations (operation 214). For example, the switch may include first ports and second ports, where the first ports are associated with communication in a LAN, the second ports are associated with communication in a WAN, and the resource expansion module may manage communication via the second ports.

Moreover, the resource expansion module may provide a processing engine that processes packets in different levels in the processing engine.

Furthermore, the resource expansion module may include or may provide the functionality of multiple NICs.

In some embodiments of method 200, there may be additional or fewer operations. Furthermore, the order of the operations may be changed, and/or two or more operations may be combined into a single operation.

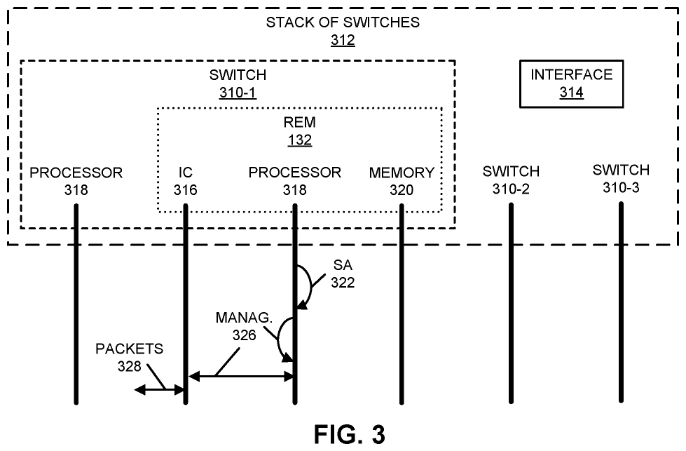

FIG. 3 presents a drawing illustrating an example of communication between switches 310 in a stack of switches (SoS) 312. Notably, switch 128 may include an interface 314 (such as a connector) that is remateably electrically and communicatively coupled to REM 132. REM 132 may include an interface circuit (IC) 316, a processor 318 and memory 320 that stores instructions for a software application (SA) 322. Moreover, processor 318 may have more capabilities or improved performance than processor 324 in switch 128 that is non-remateably included in switch 128. During operation, processor 318 may execute software application SA 322, where the software application includes: IPSec, BFD, SDN, software packet forwarding, or control plane offloading.

For example, in BFD, REM 132 may determine whether a point-to-point connection in a network is active. Alternatively or additionally, in IPSec, REM 132 may establish a connection via a secure tunnel, and encrypt or decrypt traffic communicated via the secure tunnel. In some embodiments, interface circuit 316 may include first ports and second ports, where the first ports are associated with communication in a LAN, the second ports are associated with communication in a WAN, and REM 132 may manage 326 communication via the first ports and the second ports, such as the communication of packets 328. Note that REM 132 may provide a processing engine that (e.g., virtually) processes packets in different levels in the processing engine.

While FIG. 3 illustrates some operations using unilateral or bilateral communication (which are, respectively, represented by one-sided and two-sided arrows), in general a given operation in FIG. 3 may involve unilateral or bilateral communication. Moreover, while FIG. 3 illustrates operations being performed sequentially or at different times, in other embodiments at least some of these operations may, at least in part, be performed concurrently or in parallel.

We now further describe the communication techniques. In the communication techniques a switch (such as an ICX switch from CommScope Holding Company, Inc., of Claremont, North Carolina) or a stack of switches may be converted into a network function virtualization host using a pluggable module (which is sometimes referred to as a ‘resource expansion module’). More generally, the communication techniques may be used with one or more switches from an arbitrary manufacturer or provider. The pluggable module may provide additional processing (such as a general purpose CPU) and memory (such as RAM) capabilities. The pluggable module may enable additional software capabilities, such as IPSec, BFD or smart edge.

For example, for an ICX use case, the communication techniques may be used to run IPSec or BFD on one or more selected ICX switches. Alternatively or additionally, the communication techniques may be used to provide separate software forwarding plane and control plane offloading thereby increasing the features and scales of the one or more ICX switches. In a smart edge use case, an ICX switch may be converted to smart edge hardware with ICX ports servicing a LAN and the pluggable module ports servicing a WAN. Moreover, the pluggable module may include a smart NIC, thereby allowing this capability to be integrated into performance conscious deployments.

Note that a LAN may include a network of computers and devices connected within a limited geographic area (such as a home, office, or building), enabling communication and resource sharing. Moreover, a WAN may connect electronic devices and networks across a large geographic area (such as cities, countries, or even globally), enabling communication and data sharing between geographically dispersed locations.

The pluggable module may enable a variety of use cases. For example, functionality (such as deep packet inspection or DPI, or features not supported in a packet processor) that require software forwarding plane to scale may otherwise be limited by an existing architecture of a switch. Moreover, the pluggable module may enable control plane (layer 3) scaling. Note that, in these embodiments, a forwarding plane may be tied together with a control plane in the same processor/process.

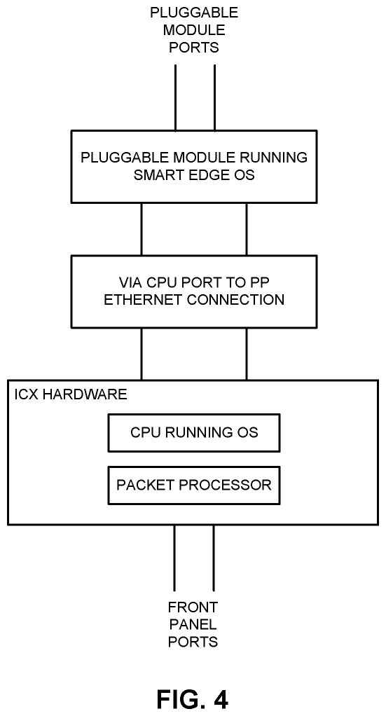

We now illustrate pluggable module configurations. FIG. 4 presents a drawing illustrating an example of switches with resource expansion modules.

The pluggable module may be capable of running software data plane (such as vector packet processing or VPP) and/or free range routing (FRR) in the control plane. The operating system (OS) or software running in a main processor of the switch may act as the controller and program: the pluggable module for required data plane or control plane functionality; reuse an existing operating system design of a programming packet processor (such as multi-protocol label switching or MPLS for IPSec or redirection for BFD). Moreover, for general software data plane functionality or control plane functionality, the quality-of-service (QoS) queue may be programmed to map the appropriate traffic class(es) to the interface associated with the pluggable module. The pluggable module may allow a subset of customers who need additional functionality in the switch to obtain it.

The pluggable module may run a smart edge operating system. The smart edge operating system may become the controller and the software in the switch may switch to a standby module. Moreover, the smart edge operating system may connect to the cloud (such as computer system 112 in FIG. 1) and may establish a management plane.

Note that programming required to the ICX software and packet processor may be passed to the ICX software via the ICX configuration Google protocol buffer (GPB) Programming interface. Moreover, layer 2 configuration and layer 3 configurations that use a virtual eXtensible LAN (VxLAN) tunnel terminations on the LAN side may be offloaded to the packet processor. Furthermore, East West switching traffic in the LAN may be handled at the packet processor. Additionally, LAN to WAN traffic may flow via the pluggable module.

The pluggable module may provide a smart edge hardware solution based at least in part on tried and tested ICX hardware. It may leverage ICX packet processor functionality for LAN functionality, thereby providing line rate traffic capacity for East West traffic. Moreover, it may provide the capability for advanced Edge functionality and line rate North South traffic capability via a smart NIC by replacing the pluggable module.

For example, the pluggable module may include an Intel CPU Atom C3708 with a clock speed of 1.7 GHz and 8-cores (from Intel Corp. of Santa Clara, California). Alternatively, an Intel CPU Xenon may be used, with 64 cores and 64 GB of RAM. The processor may have a size of 34×28 mm² and may consume 17 W of power. Moreover, the pluggable module may include two 10 Gigabit Ethernet ports, a type C USB port and/or a USB type C console port. In some embodiments, the pluggable module may include one type C connector that can support a USB and a console port. Note that the total power of the pluggable module may be 35 W, which may be significantly less than the total power consumption of a server that could be used to implement the communication techniques.

In some embodiments, the communication techniques provide smart edge hardware based at least in part on an ICX pluggable module. For example, the pluggable module may be based on an Intel Atom processor. The proposed hardware layout is illustrated in FIG. 4. During bootup, two hardware devices (the ICX switch and the pluggable module) may become a smart edge device. This smart edge device may be configured by a cloud-based controller (such as computer system 112 in FIG. 1). Note that the pluggable module may be connected to a backplane in the switch to provide data rates of multiple GB/s, such as 80 Gb/s.

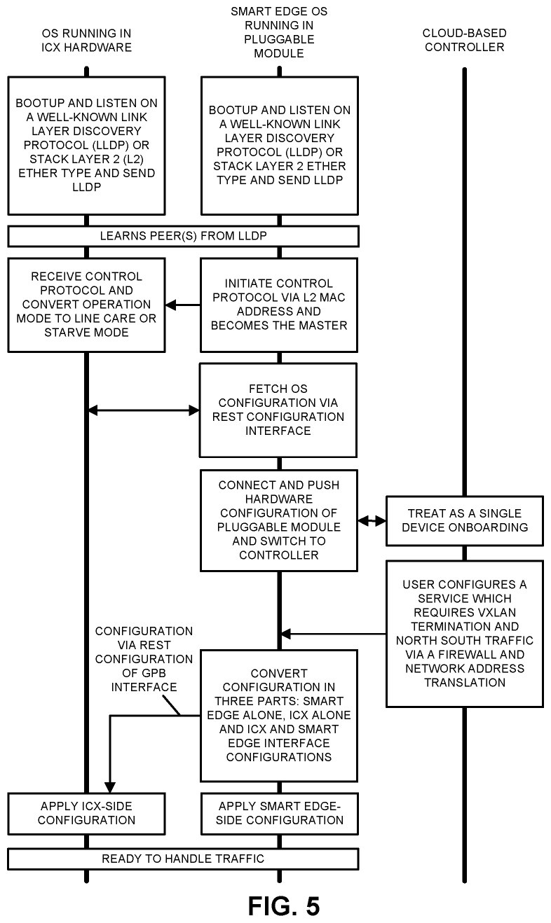

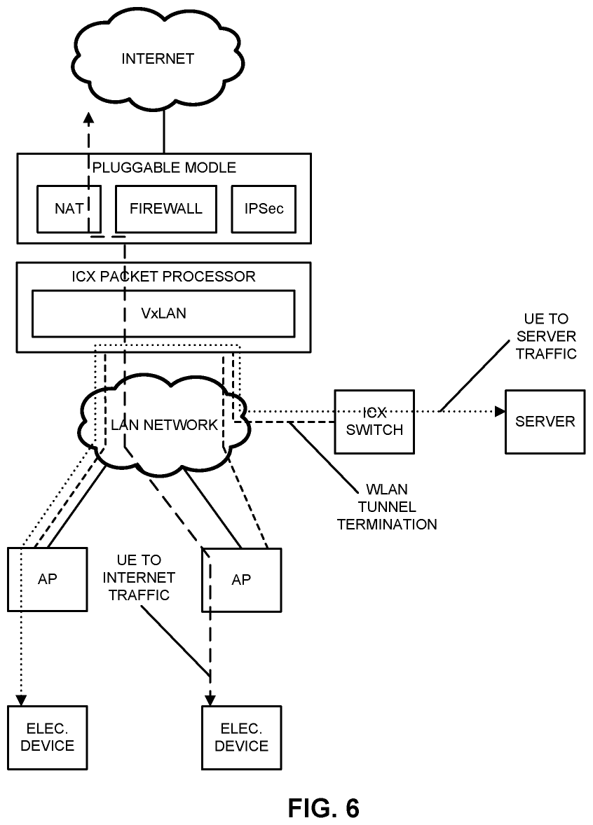

FIG. 5 presents a drawing illustrating an example of switch operation. Note that the configuration for smart edge alone may include network address translation (NAT) and firewall, and the configuration for ICX alone may include VxLAN. Moreover, the packet path is shown in FIG. 6, which presents a drawing illustrating an example of communication in a network. In FIG. 6, the user equipment (UE) to Internet traffic may be terminated at the VxLAN by the packet processor, forwarded to the pluggable module for firewall and network address translation, and forwarded to the Internet via the smart edge interface.

In some embodiments, the communication techniques may be used in a cluster or a stack of switches. For example, the communication techniques may leverage ICX Stacking capability and interfaces to extend the smart edge functionality for load balancing and/or port extension use cases.

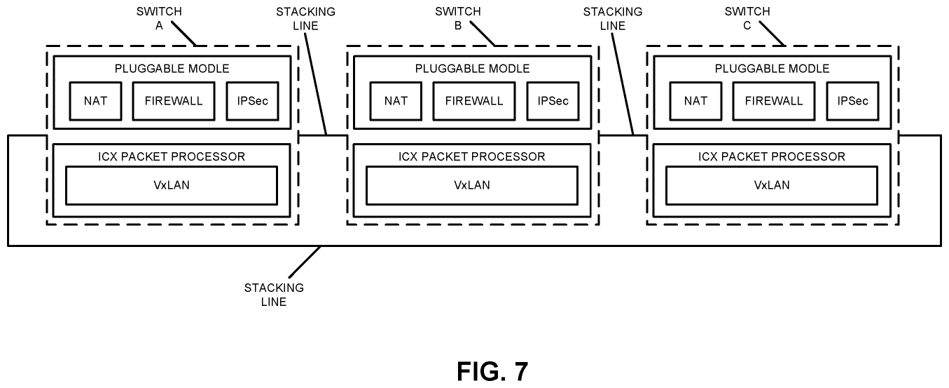

FIG. 7 presents a drawing illustrating an example of load balancing. In these embodiments, multiple switches or nodes have both an ICX packet processor a smart edge plugin card (or pluggable module). The ICX switches may be connected over a stacking Link and the smart edge plugin cards may also be clustered via the stacking link. Note that the switches or nodes may be capable of doing both VxLAN tunnel termination and/or smart edge functionalities, and may operate in a load balanced mode. The switches in FIG. 7 may provide service and switching.

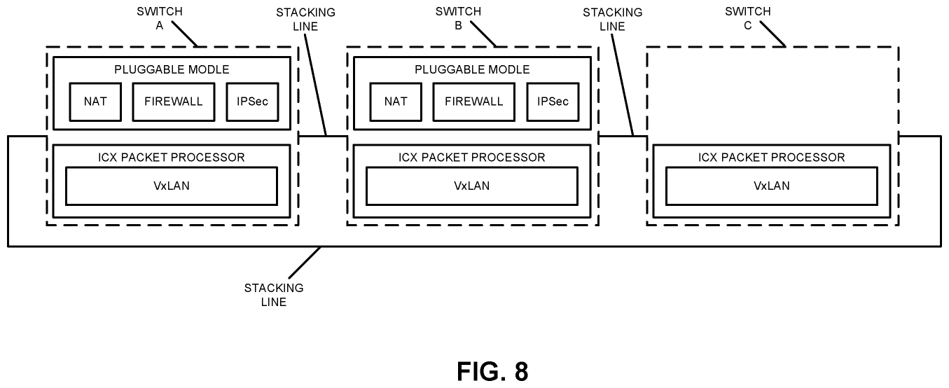

FIG. 8 presents a drawing illustrating an example of port extension. In these embodiments, at least some of the nodes or switches may have both an ICX packet processor and a smart edge plugin card (or pluggable module). The remaining nodes or switches may have only ICX packet processors. The nodes or switches with both an ICX packet processor and a smart edge plugin card may be capable of doing both VxLAN tunnel termination and smart edge functionalities, and may operate in a load balanced mode. Moreover, the nodes or switches with only ICX packet processors may be capable of VxLAN tunnel termination. For smart edge functionalities, these nodes or switches may be assigned to one of the nodes or switches with load balancing capability. Thus, the switches in FIG. 8 with the pluggable modules may provide service and switching, while the remaining switches may only provide switching.

We now describe embodiments of an electronic device, which may perform at least some of the operations in the communication techniques. FIG. 9 presents a block diagram illustrating an example of an electronic device 900 in accordance with some embodiments, such as one of: base station 108, one of electronic devices 110, computer system 112, one of access points 116, one of radio nodes 118, switch 128 or authentication computer 130. This electronic device includes processing subsystem 910, memory subsystem 912, and networking subsystem 914. Processing subsystem 910 includes one or more devices configured to perform computational operations. For example, processing subsystem 910 can include one or more microprocessors, graphics processing units (GPUs), ASICs, microcontrollers, programmable-logic devices, and/or one or more digital signal processors (DSPs).

Memory subsystem 912 includes one or more devices for storing data and/or instructions for processing subsystem 910 and networking subsystem 914. For example, memory subsystem 912 can include DRAM, static random access memory (SRAM), and/or other types of memory. In some embodiments, instructions for processing subsystem 910 in memory subsystem 912 include: one or more program modules or sets of instructions (such as program instructions 922 or operating system 924, such as Linux, UNIX, Windows Server, or another customized and proprietary operating system), which may be executed by processing subsystem 910. Note that the one or more computer programs, program modules or instructions may constitute a computer-program mechanism. Moreover, instructions in the various modules in memory subsystem 912 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 910.

In addition, memory subsystem 912 can include mechanisms for controlling access to the memory. In some embodiments, memory subsystem 912 includes a memory hierarchy that comprises one or more caches coupled to a memory in electronic device 900. In some of these embodiments, one or more of the caches is located in processing subsystem 910.

In some embodiments, memory subsystem 912 is coupled to one or more high-capacity mass-storage devices (not shown). For example, memory subsystem 912 can be coupled to a magnetic or optical drive, a solid-state drive, or another type of mass-storage device. In these embodiments, memory subsystem 912 can be used by electronic device 900 as fast-access storage for often-used data, while the mass-storage device is used to store less frequently used data.

Networking subsystem 914 includes one or more devices configured to couple to and communicate on a wired and/or wireless network (i.e., to perform network operations), including: control logic 916, an interface circuit 918 and one or more antennas 920 (or antenna elements). (While FIG. 9 includes one or more antennas 920, in some embodiments electronic device 900 includes one or more nodes, such as antenna nodes 908, e.g., a metal pad or a connector, which can be coupled to the one or more antennas 920, or nodes 906, which can be coupled to a wired or optical connection or link. Thus, electronic device 900 may or may not include the one or more antennas 920. Note that the one or more nodes 906 and/or antenna nodes 908 may constitute input(s) to and/or output(s) from electronic device 900.) For example, networking subsystem 914 can include a Bluetooth™ networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, and/or another networking system.

Note that a transmit or receive antenna pattern (or antenna radiation pattern) of electronic device 900 may be adapted or changed using pattern shapers (such as directors or reflectors) and/or one or more antennas 920 (or antenna elements), which can be independently and selectively electrically coupled to ground to steer the transmit antenna pattern in different directions. Thus, if one or more antennas 920 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 900 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 914 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 900 may use the mechanisms in networking subsystem 914 for performing simple wireless communication between the electronic devices, e.g., transmitting advertising or beacon frames and/or scanning for advertising frames transmitted by other electronic devices as described previously.

Within electronic device 900, processing subsystem 910, memory subsystem 912, and networking subsystem 914 are coupled together using bus 928. Bus 928 may include an electrical, optical, and/or electro-optical connection that the subsystems can use to communicate commands and data among one another. Although only one bus 928 is shown for clarity, different embodiments can include a different number or configuration of electrical, optical, and/or electro-optical connections among the subsystems.

In some embodiments, electronic device 900 includes a display subsystem 926 for displaying information on a display, which may include a display driver and the display, such as a liquid-crystal display, a multi-touch touchscreen, etc.

Moreover, electronic device 900 may include a user-interface subsystem 930, such as: a mouse, a keyboard, a trackpad, a stylus, a voice-recognition interface, and/or another human-machine interface. In some embodiments, user-interface subsystem 930 may include or may interact with a touch-sensitive display in display subsystem 926.

Electronic device 900 can be (or can be included in) any electronic device with at least one network interface. For example, electronic device 900 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 900, in alternative embodiments, different components and/or subsystems may be present in electronic device 900. For example, electronic device 900 may include one or more additional processing subsystems, memory subsystems, networking subsystems, and/or display subsystems. Additionally, one or more of the subsystems may not be present in electronic device 900. Moreover, in some embodiments, electronic device 900 may include one or more additional subsystems that are not shown in FIG. 9. Also, although separate subsystems are shown in FIG. 9, in some embodiments some or all of a given subsystem or component can be integrated into one or more of the other subsystems or component(s) in electronic device 900. For example, in some embodiments instructions 922 is included in operating system 924 and/or control logic 916 is included in interface circuit 918.

Moreover, the circuits and components in electronic device 900 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 914 and/or of electronic device 900. The integrated circuit may include hardware and/or software mechanisms that are used for transmitting wireless signals from electronic device 900 and receiving signals at electronic device 900 from other electronic devices. Aside from the mechanisms herein described, radios are generally known in the art and hence are not described in detail. In general, networking subsystem 914 and/or the integrated circuit can include any number of radios. Note that the radios in multiple-radio embodiments function in a similar way to the described single-radio embodiments.

In some embodiments, networking subsystem 914 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals).

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi, LTE and/or Ethernet communication protocols as illustrative examples, in other embodiments a wide variety of communication protocols and, more generally, communication techniques may be used. Thus, the communication techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the communication techniques may be implemented using program instructions 922, operating system 924 (such as a driver for interface circuit 918) or in firmware in interface circuit 918. Alternatively or additionally, at least some of the operations in the communication techniques may be implemented in a physical layer, such as hardware in interface circuit 918.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A switch, comprising:
an interface configured to remateably electrically and communicatively couple to a resource expansion module, wherein the resource expansion module comprises a processor and memory, and the processor has more capabilities than a second processor that is non-remateably included in the switch, and wherein the resource expansion module is configured to perform one or more operations comprising:
executing a software application on the processor in the resource expansion module,
wherein the software application comprises: Internet Protocol Security (IPSec), Bidirectional Flow Detection (BFD), Software-Defined Networking (SDN), software packet forwarding, or control plane offloading.

2. The switch of claim 1, wherein the switch is included in a stack of switches.

3. The switch of claim 2, wherein the switch is at an arbitrary location in the stack of switches.

4. The switch of claim 1, wherein the memory comprises random access memory (RAM) that stores software instructions for the software application.

5. The switch of claim 1, wherein the switch comprises first ports and second ports, and
wherein the first ports are associated with communication in a LAN, the second ports are associated with communication in a wide area network (WAN), and the resource expansion module is configured to manage communication via the second ports.

6. The switch of claim 1, wherein, in BFD, the resource expansion module is configured to determine whether a point-to-point connection in a network is active.

7. The switch of claim 1, wherein, in IPSec, the resource expansion module is configured to establish a connection via a secure tunnel, and encrypt or decrypt traffic communicated via the secure tunnel.

8. The switch of claim 1, wherein the resource expansion module is configured to provide a processing engine that processes packets in different levels in the processing engine.

9. The switch of claim 1, wherein the resource expansion module comprises a Universal Serial Bus (USB) type C port.

10. The switch of claim 1, wherein, the resource expansion module comprises or provide functionality of multiple network interface cards (NIC).

11. A method for executing a software application, comprising:
by a switch:
executing the software application on a processor in a resource expansion module,
wherein the software application comprises: Internet Protocol Security (IPSec), Bidirectional Flow Detection (BFD), Software-Defined Networking (SDN), software packet forwarding, or control plane offloading,
wherein the resource expansion module is remateably electrically and communicatively coupled to the switch,
wherein the resource expansion module comprises a processor and memory, and
wherein the processor has more capabilities than a second processor that is non-remateably included in the switch.

12. The method of claim 11, wherein the switch is included in a stack of switches; and
wherein the switch is at an arbitrary location in the stack of switches.

13. The method of claim 11, wherein the switch comprises first ports and second ports, and
wherein the first ports are associated with communication in a LAN, the second ports are associated with communication in a wide area network (WAN), and the resource expansion module manages communication via the second ports.

14. The method of claim 11, wherein, in BFD, the resource expansion module is configured to determine whether a point-to-point connection in a network is active.

15. The method of claim 11, wherein, in IPSec, the resource expansion module establishes a connection via a secure tunnel, and encrypt or decrypt traffic communicated via the secure tunnel.

16. The method of claim 11, wherein the resource expansion module provides a processing engine that processes packets in different levels in the processing engine.

17. A stack of switches, comprising:
multiple switches, wherein at least a subset of the switches are interconnected and configured to communicate with each other, and wherein a first switch in the switches comprises:
an interface configured to remateably electrically and communicatively couple to a resource expansion module, wherein the resource expansion module comprises a processor and memory, and the processor has more capabilities than a second processor that is non-remateably included in the first switch, and wherein the resource expansion module is configured to perform one or more operations comprising:
executing a software application on the processor in the resource expansion module,
wherein the software application comprises: Internet Protocol Security (IPSec), Bidirectional Flow Detection (BFD), Software-Defined Networking (SDN), software packet forwarding, or control plane offloading.

18. The stack of switches of claim 17, wherein the first switch is at an arbitrary location in the stack of switches.

19. The stack of switches of claim 17, wherein, in BFD, the resource expansion module is configured to determine whether a point-to-point connection in a network is active.

20. The stack of switches of claim 17, wherein, in IPSec, the resource expansion module establishes a connection via a secure tunnel, and encrypt or decrypt traffic communicated via the secure tunnel.
